(19) United States
(12) Patent Application Publication
(10) Pub. No.: US 2025/0230071 A1
(43) Pub. Date: Jul. 17, 2025

(54) HIGH-THROUGHPUT LOW-PRESSURE WATER SOFTENING ELECTROLYZER

(71) Applicant: RST Cleantech Ltd, Tel-Aviv (IL)

(72) Inventors: Roy SADE, Tel-Aviv (IL); Shani BAKALIAR, Tel-Aviv (IL)

(73) Assignee: RST Cleantech Ltd, Tel-Aviv (IL)

(21) Appl. No.: 18/856,649

(22) PCT Filed: Mar. 14, 2023
(86) PCT No.: PCT/IL2023/050268

§ 371 Date: Oct. 14, 2024

Related U.S. Application Data
(60) Provisional application No. 63/330,832, filed on Apr. 14, 2022.

(51) Int. Cl. C02F 1/46; C02F 1/461; C25B 1/04; C25B 9/17; C25B 11/02; C25B 11/052; C25B 11/063; C25B 11/075

(52) U.S. Cl. CPC C02F 1/4602; C02F 1/46109; C25B 1/04; C25B 9/17; C25B 11/02; C25B 11/052; C25B 11/063; C25B 11/075; C02F 2001/46142; C02F 2001/46171; C02F 2201/4614; C02F 2201/46145; C02F 2201/4616; C02F 2209/03

(57) ABSTRACT

A high-output tap water softening electrolyzer device, housed in a non-metal casing and configured for low internal pressure buildup and a method of using the same are provided herein, wherein the casing and the lid of the device are made essentially from a polymeric material rather than a metal.

### RELATED APPLICATION/S

This application claims the benefit of priority of U.S. Provisional Patent Application No. 63/330,832 filed on 14 Apr. 2022, the contents of which are incorporated herein by reference in their entirety.

### FIELD AND BACKGROUND OF THE INVENTION

The present invention, in some embodiments thereof, relates to water treatment methodologies, and more particularly, but not exclusively, to an electrochemical device for water scaling treatment.

In many parts of the world domestic and industrial water contains calcium (Ca), magnesium (Mg) and carbonate ions (CO₃⁻² or HCO₃⁻) which cause scaling problems in the installations leading to failures, including pipe blocking, membrane clogging, efficiency decay of heaters, heat exchangers as well as diminishing the optical appearance of glasses and PV solar panels.

Various methods are used to prevent scaling: for example, by acidification of the water, or by forcing the Ca-carbonate precipitation by some chemical process, by using ion exchange resins, or by membrane techniques (reverse osmosis, nanofiltration etc.). Another way consists in blocking the nucleation and crystal growth via the use of chemical inhibitors. However, these chemicals are generally impacting human health and the environment, and their use is forbidden in drinking and potable water.

Industrial or domestic water can also be treated with the method based on water electrolysis

[Sanjuán, I. et al., “Electrochemical water softening: Influence of water composition on the precipitation behavior”, Separation and Purification Technology, 211 (2019) 857-865; Hao, X. et al., “Research and application progress of electrochemical water quality stabilization technology for recirculating cooling water in China: A short review”, Journal of Water Process Engineering, 37 (2020) 101433]. The water to be treated circulates in an electrolyzer (an electrochemical cell where water electrolysis is taking place), where an electrical current pass between a set of electrodes. The most common electrochemical treatments to lower water hardness (water softening or descaling) is based on the electrochemical precipitation (EP) principle, which removes water hardness-causing ions through the formation a high pH environment at the surface of the cathode, as shown in the following reactions:

2H₂O+2e⁻→H_{2(g)}↑+2OH⁻
or

O_{2(aq)}+2H₂O+4e⁻→4OH⁻

The alkaline environment leads to the following precipitation reactions:

Ca²⁺+HCO₃⁻+OH⁻→CaCO₃₍ₛ₎↓+H₂O)
and

Mg²⁺+2OH−→Mg(OH)₂₍ₛ₎↓

The main anodic reactions are electrolytic reaction of H₂O, generating oxygen on dimensionally stable anodes (DSA). The DSA anode is made of or coated with catalytic materials, generating oxygen at a very low overpotential.

Hence, an electrochemical softening unit function in one of two paths: a cathodic reaction involving oxygen (produced at the anode) reduction to hydroxide at the cathode; or a cathodic reaction wherein water is reduced to produce hydroxide ions and hydrogen gas.

A scale layer consisting mainly of calcium carbonate and Mg-hydroxide, is deposited on the surface of the cathode. This scales layer is typically loose and falls spontaneously, or in an assisted manner (mechanical scraper, reverse wash, or a simple gravimetric drainage), and is collected as a slurry or powder at the bottom of the reaction vessel.

The currently known electrolyzer devices suffer from one or more problems associated with internal pressure due to the evolution of gases, and/or water throughput limitations, rendering these devices less practical for domestic and most industrial uses.

Gabrielli, C. et al. [“Electrochemical water softening: principle and application”, Desalination, 201 (2006) 150-163] presents some of the various electrochemical softening devices proposed on the market. In these devices the electrolysis is carried out at constant current intensity or at a constant potential difference between the terminals, in a vessel where water slowly flows. The scale is deposited without limit, leading to thick layers up to several millimeters. They can be spontaneously detached, but it is sometimes necessary to assist the detachment by a mechanical action. The geometry of the electrolyzers are either cylindrical with coaxial electrodes or parallelepiped with parallel plates. The electrodes are typically made of non-corrodible materials (stainless steel, titanium, titanium clad iridium etc.). As many others, Gabrielli's electrolyzer works under considerable high pressure, thereby limiting the usability of the device to low outputs or highly fortified metal casing equipped with the proper safety measures against explosion.

Summarizing the state of the art in the field, two approaches for hydroxide formation at the cathode electrode of the electrolyzers are known: the first one adopts the high hydroxide formation via a massive water reduction, thus generating hydrogen gas, while the second one states that the hydroxide can be formed at the cathode via a reduction of dissolved oxygen in water, which has to migrate to the cathode and is in limited supply.

### SUMMARY OF THE INVENTION

The present disclosure provides a water treatment device, configured to descale (soften) tap water by electrolysis at a flow rate that is suitable for washing large surfaces, such as solar panels, while maintaining a low internal pressure. The device operates at specific voltage and current density that keeps the electrolysis reaction in “oxygen starvation” mode throughout, thereby preventing hydrogen from forming while at the same time consuming essentially all the oxygen that is naturally dissolved in the input water and/or generated during the reaction. At its herein-provided configuration, the presently disclosed electrolyzer does not generate excess gases, neither oxygen (due to the constraint on the current density) nor hydrogen (due to the constraint on the polarization potential), and can therefore be encased in a relatively simple housing made of plastic, or in other words, the housing of the herein-provided water softening electrolyzer device is not required to withstand high pressure (e.g., over 1.2 atm).

Thus, according to an aspect of some embodiments of the present invention, there is provided a water softening electrolyzer device, which includes and is characterized by having:

an anode;

a cathode;

a casing that comprises a top lid having a water inlet and a water outlet;

the anode and the cathode are each held at a fixed position by an anchor wire-guide for eclectically contact and positioning inside the casing; and

the casing is having a backwash drainage at the bottom thereof,

wherein:

the casing is made of a polymeric material;

the anode having a cylindrical or flat shape and positioned substantially at the center and along a longitudinal axis of the casing;

the cathode is cylindrical and positioned along a longitudinal axis of the casing, essentially around the anode, such that the anode is at a concentric position with respect to the cathode; and

the active surface area of the cathode is at least twice the active surface area of the anode.

In some embodiments, the device further includes an electric power source configured to operate at:

a polarization potential that ranges from about −1.1 V to about −0.9 V against a saturated calomel electrode (SCE); and

a current density of less than about 10 mA/cm².

In some embodiments, the device is configured to electrochemically descale water at a flow rate of at least 3 m3/h while maintaining an internal pressure of less than 1.2 atm.

In some embodiments, the internal pressure is formed essentially from oxygen gas.

In some embodiments, the device further includes at least one of:

a water flow detector;

a water flow controller;

an electrical current controller;

a gas pressure detector; and

a head-space vent.

In some embodiments, the anode comprises a corrosion-resistant conductor core and an oxide coating.

In some embodiments, the resistant conductor core is a titanium plate.

In some embodiments, the oxide coating comprises a conductive catalyst selected from the group consisting of RuO₂, IrO₂, and PtO₂.

In some embodiments, the casing is having a cylindrical or truncated cone shape.

According to another aspect of some embodiments of the present invention, there is provided a process for descaling tap water, which is effected by:

flowing the tap water through the device provided herein at a flow rate of at least 3 m3/h,

the process is characterized by developing an internal pressure of less than 1.2 atm.

In some embodiments, the process is effected while maintaining:

a polarization potential between the anode and the cathode at a range of about −1.1 V to about −0.9 V against a saturated calomel electrode (SCE); and

a current density of less than about 10 mA/cm².

In some embodiments, the process is characterized by electrochemically producing O₂ at a rate of at least 50 gram/h.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

When applied to an original property, or a desired property, or an afforded property of an object or a composition, the term “substantially maintaining”, as used herein, means that the property has not change by more than 20%, 10% or more than 5% in the processed object or composition.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents a schematic illustration of a high output low pressure water softening electrolyzer, according to some embodiments of the present invention, showing a side view of device 10, having polymeric casing 11 and polymeric lid 12 sealing casing 11 and fitted tap water inlet 13 and softened water outlet 14, and showing backwash drainage opening 15 at the bottom of casing 11 for backwashing mineral sediment therefrom, and sealed wire-guide anchor 16 for holding and eclectically contacting anode 17, and sealed wire-guide anchor 18 for holding and eclectically contacting cathode 19;

FIG. 2 presents a schematic illustration of a high output low pressure water softening electrolyzer, according to some embodiments of the present invention, showing a side view of device 20, having polymeric casing 21 having screw threads 22 and O-ring seal 23 for tightening the polymeric lid (not shown), and backwash drainage opening 24 at the bottom of casing 21, and showing anode 25 cathode 26;

FIG. 3 presents a schematic illustration of a high output low pressure water softening electrolyzer, according to some embodiments of the present invention, showing a top view of device 30, having polymeric casing 31, sealed wire-guide anchor 32 for holding and eclectically contacting anode 33, and sealed wire-guide anchor 33 for holding and eclectically contacting cathode 34; and

FIG. 4 presents a schematic illustration of a screw cap lid of a high output low pressure water softening electrolyzer device, according to some embodiments of the present invention, showing a side view of polymeric lid 40 for capping and sealing a polymeric casing of the device (not shown), having screw threads 42, tap water inlet 43 and softened water outlet 44, and optional head-space vent 45 for priming the device by releasing air trapped in the device before, during and after operation of the device.

### DESCRIPTION OF SPECIFIC EMBODIMENTS OF THE INVENTION

The present invention, in some embodiments thereof, relates to water treatment methodologies, and more particularly, but not exclusively, to an electrochemical device for water scaling treatment.

Before explaining at least one embodiment of the invention in detail, it is to be understood that the invention is not necessarily limited in its application to the details set forth in the following description or exemplified by the Examples. The disclosure is meant to encompass other embodiments or of being practiced or carried out in various ways.

While searching for a solution to the problems of pressure buildup and water throughput limitations, plaguing the available electrolyzers in the water softening market, the present inventors have considered that during water electrolysis, dissolved oxygen is reduced on the cathode in a large potential range by following the global electrochemical reaction:

O₂+2H₂O+4e⁻→4OH⁻

The oxygen diffusion limits the rate of this reaction and leads to a current plateau on the representative polarization curve. When the applied potential is more negative, water is directly reduced according to:

2H₂O+2e⁻→H_{2(g)}↑+2OH⁻

It is known that the rate of this reaction is not limited by mass transport and the current intensity can be very high. The generation of hydroxyl ions, by either reactions de-stabilizes the Ca-bicarbonate ions equilibrium within the solution, and bicarbonate ions [HCO₃⁻] are converted into carbonate ions [CO₃²⁻] by the following chemical reaction:

HCO₃⁻+OH−→CO₃²⁻+H₂O

In a third step, carbonate ions may react with calcium ions to initiate the nucleation and growth of calcium carbonate crystals:

CO₃²⁻+Ca²⁺→CaCO₃₍ₛ₎↓

While for sedimentation of solid Mg hydroxide the direct chemical reaction between hydroxides and Mg ions is taking place:

Mg²⁺+2OH−→Mg(OH)_{2↓}

In terms of polarization, the present inventors have considered the polarization curve and noted that the current density as a function of the electrochemical potential vs. saturated calomel electrode indicates a range of potential in which oxygen is consumed and hydrogen generation is still minimal: about −0.9 to about −1.1 V (see, Gabrielli, C. et al. [“Electrochemical water softening: principle and application”, Desalination, 201 (2006) 150-163]). At a potential lower (more negative) than −1.1 V, H₂ evolution increases exponentially, rendering the reaction system prone to pressure buildup and explosion, and combustion hazards.

For example, the electrolyzer presented in Gabrielli et al., which can treat up to several m³/h, the cathodic reaction is driven to hydrogen evolution reaction via water reduction (polarizing the electrode potential below −1.2 V achieving reduction currents of a few dozens of mA/cm²), thus producing a high concentration of hydroxides. However, the downside of such units is that the internal pressure within the unit is high and means to safely release hydrogen are needed. These devices produce oxygen which is not used for hydroxide formation at the cathode, as this is being done via the massive reduction of water in which hydrogen gas by-product.

If one seeks to avoid the hydrogen evolution, one may need to force the unit to work in the region of oxygen reduction potentials (−0.9 to −1.1 V) and at current densities slightly less than 10 mA/cm². Most of the research and development in the field focused on overcoming mass transport issues, thus enabling on one hand a substantial formation of oxygen at a dimensionally stable anode (DSA) to support and overcome mass transport issues of oxygen to the cathode side. Typically, one applies enough current to produce oxygen over the saturation limits in tap water. In such circumstance, there is no need to be concerned with the transport of oxygen to the cathode surface, as water is rich with dissolved oxygen (saturation). However, the excess of oxygen, building a pressure in the system, must be released.

While conceiving the present invention, the present inventors considered that when the polarization is only restricted to the oxygen reduction domain (potential wise), one need to consider the rate of oxygen consumption, considering its availability in the treated water and the ways to maintain a continuous formation, supply, and consumption of the oxygen.

As stated above, traditionally, oxygen is being produced in excess to support its consumption at the cathode surface. While further conceiving the present invention, the present inventors have recognized that the major challenge is to produce an efficient electrolyzer unit which holds no or little internal pressure and thus, such a system can be built from soft materials (polymers; plastic materials), rather than metals, capable of holding the internal pressure being built upon a continuous operation of the unit.

While reducing the present invention to practice, the inventors have taken into account that oxygen solubility in pure or fresh water at 25° C. and 1.0 atm of O₂ pressure is about 1.22×10−3 mol dm−3 (the values are varied from 1.18 to 1.25 mol dm−3 as reported in the literature). In ambient air, the oxygen partial pressure is 0.21 atm, the O₂ solubility would become 2.56×10−4 mol dm−3 (multiplied by 32 to account for the molecular weight of oxygen) to yield up to about 8.0 mg/l or 8.0 g/cubic meter of water.

Typically, oxygen solubility depends on (1) the amount of dissolved electrolyte(s) (decreases at higher concentration of electrolyte/dissolved salt); (2) temperature (decreases at higher temperatures); and (3) pressure (increases at higher pressure). If one considers a unit of electrolyzer as being under a pressure of 1 atm of oxygen, one can expect a solubility of 1.22 moles/m³, corresponding to a mass of 1.22×32 g/mol=268.8 gr/m³.

While one of the objectives of the present invention is to provide an efficient electrolyzer that can operate at high output with little to no internal pressure buildup, the problem to be solved is how to produce enough oxygen to constantly support high solubility at the atmospheric pressure of pure oxygen, while consuming it for hydroxide production at the same rate, without building up any oxygen internal pressure within the cell.

The presently disclosed approach of such efficient and low-pressure electrolyzer calls for a controlled starvation of the cathode with oxygen, being produced at the anode. The approach of providing more than enough oxygen to support the oxygen reduction at the cathode was questioned by the opposite and counter intuitive thinking of producing oxygen in a “lesser manner”, in such way that the cathode will be always in a “starvation mode”, i.e., that each oxygen molecule being produced at the anode, will migrate to the cathode without the ability to escape the system and accumulate as internal pressure within the device's headspace. Avoiding accumulation of oxygen in the headspace is expected as oxygen is present in the system at a lower concentration that oxygen saturation, while the dissolved oxygen is attracted to the cathode side via the electric fields being imposed at the cathode. Moreover, the inventors have contemplated a device in which the atmosphere in the headspace volume is essentially oxygen gas at a pressure of about 1-1.2 atm, thereby harnessing the high solubility of oxygen in the high flow rate electrolyzer device that consumes the majority of the oxygen gas that is being generated during the operation of the device.

### Electrochemical Water Softening Device and Water Treatment Process Features

The rudimentary principle of the electrolyzer device provided herein includes softening tap water at a high flow rate using a low-pressure, and thus low-cost device housing, such as a polymeric (plastic) housing. This feat is achieved, according to some embodiments of the present invention, by the following characteristics of the device, the required flow rate and the optimal electrical parameters.

Hard water is formed when water percolates through deposits of limestone, chalk or gypsum, which are largely made up of calcium and magnesium carbonates, bicarbonates and sulfates. Water that originates in ground water is typically hard and requires softening in order to be suitable for use in washing solar panels—in other words, tap water typically requires softening (turning hard water into soft water). In the context of the present invention, the term “softening” refers to the reduction of minerals in water. According to some embodiment, the term “softening” refers to the reduction of the concentration of calcium and magnesium species in tap water. According to some embodiment, the term “softening” refers to an electrochemical process that reduces the concentration of calcium carbonate in tap water to below 60 ppm. In the context of the present invention, the herein-provided device is configured to lower the mineral concentration of hard to moderately hard input water from or 500 ppm, or 450 ppm, or 300 ppm, or 250 ppm, or 200 ppm, or 180 ppm, or 120 ppm, to 60 ppm or less.

One of the requirements of the device and its mode of operation is to provision of softened water at a relatively high flow rate. This requirement is harnessed to ensure fresh supply of dissolved oxygen into the device. In some embodiments, the flow rate is at least 3 m³/h.

Another requirement is to operate the device at a polarization potential that does not support hydrogen evolution, namely in some embodiments the polarization potential is set to range from about −1.1 V to about −0.9 V (potential values against a saturated calomel electrode (SCE)).

Yet another requirement is to operate the device at “oxygen starvation mode”, which is achieved by adjusting the current density such that essentially all the oxygen in the system is consumed in the electrochemical reaction at a rate that commensurate the input of external dissolved oxygen and oxygen that evolves during the electrochemical reaction. The current density is a function of several factors, including the electrodes' shape, size and relative surface area ratio between the anode and the cathode, and the input current. According to some embodiments, the current density that is used in the device is less than about 10 mA/cm², preferably with respect to the surface area of the cathode.

When the device is used under the above settings, it provides sufficiently softened water (60 ppm of minerals in the water or less) at a useful flow rate (at least 3 m³/h) while maintaining an internal pressure of less than 1.2 atm (essentially no production of excess gas during operation). If the flow rate is higher or needed at higher output, and/or if the hardness of the input water is higher, the current density can be adjusted accordingly by, e.g., following the internal pressure in the device.

During prolonged use, the device requires periodic emptying of the mineral sediment. The sediment can be backwashed through the backwash drainage opening at the bottom of the casing. The frequency of the sediment purge depends inter alia on the hardness of the input water, the flow rate, the duration of the operation, and the size of the casing.

### Low-pressure High-Output Electrolyzer

Hence, the presently disclosed electrolyzer is characterized by a non-metal casing (housing). Due to the herein-provided configuration and working parameters that is characterized by being substantially devoid of undesired accumulation of excess gases, such as oxygen and hydrogen), the casing can be made of a polymeric material, a plastic material, or of a thin metal which does not have to withstand high pressure.

The presently disclosed electrolyzer is characterized by a flow configuration that allows a flow of water at a rate of at least 4 m³/h, at least 5 m³/h, at least 6 m³/h, at least 7 m³/h, at least 8 m³/h, at least 9 m³/h or at least 10 m³/h. The flow configuration allows the water passing through the device to pass through the entire volume of the casing, providing maximal contact with the electrodes and allowing effective exchange of the case contents. The headspace of the device is kept minimal and the flow is optionally monitored and controlled together with the electrical current to optimize oxygen consumption at “starvation mode”, thereby mitigating the problem of pressure buildup.

According to some embodiments of the present invention, the system is configured to exhibit a polarization that is restricted to the oxygen reduction domain, namely the region of −0.9 V to −1.1 V potentials. The system is configured also to operate at current densities slightly less than 10 mA/cm².

The presently disclosed electrolyzer is characterized by a dimensionally stable anode (DSA) to support and overcome mass transport issues of oxygen to the cathode side. DSA is also known as a mixed metal oxide (MMO) electrode. DSA is typically used in electrolysis devices due toothier high conductivity and corrosion resistance. They are typically made by coating a substrate, such as pure titanium plate or expanded mesh, with several kinds of metal oxides. In some embodiments, one oxide is RuO₂, IrO₂, or PtO₂, which conducts electricity and catalyzes the desired reaction. The other metal oxide is typically titanium dioxide which does not conduct or catalyze the reaction, but is cheaper and prevents corrosion of the interior.

The presently disclosed electrolyzer is characterized by a large surface area anode, which is selected proportional to the desired flow output (flow rate) and current constraints. The general relative proportions may be deduced from the calculations in the examples presented herein.

The presently disclosed electrolyzer is also characterized by a cathode/anode surface ratio in which the cathode surface area is more than double the surface area of the anode. In some embodiments, the surface area of the cathode is at least 2X (twice), 3X, 4X or 5X the surface area of the anode.

The presently disclosed electrolyzer is further characterized by relative placement of the cathode with respect to the anode, with the intention to facilitate oxygen transport. Hence, in some embodiments, the cathode/anode pair are configured in a concentric manner, such that the cathode surrounds the whole geometric surface of the anode. An exemplary design would be a cylindrical shaped cathode surrounding the anode, which is a plate or cylinder concentric with respect to the cathode. In some embodiments, the cathode is shaped as a perforated open cylinder, and the anode is place in the center of the cylindrical cathode and shaped as a plate. In some embodiments, the cathode and/or the anode are perforated in order to increase the active surface area thereof.

The presently disclosed electrolyzer is further characterized by including the means to control the flow rate and the current in the system, so as to maintain the “oxygen starvation” conditions throughout the operation of the device. While the potential is restricted to oxygen reduction potentials, and the flow rate is also required to provide a minimal output below which the device provides too little output, the most simple and available mean for controlling the operation of the device is via the current. Thus, according to some embodiments, the device includes oxygen level detectors, which may monitor headspace pressure, oxygen concentration in the water, and other parameter(s) that indicate whether the system is indeed in “oxygen starvation” conditions.

It is expected that during the life of a patent maturing from this application many relevant low-pressure water-softening electrolyzers will be developed and the scope of the phrase “low-pressure water-softening electrolyzer” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions, illustrate some embodiments of the invention in a non-limiting fashion.

### Example 1

### Low Internal Pressure High Output Water Softening Electrolyzer

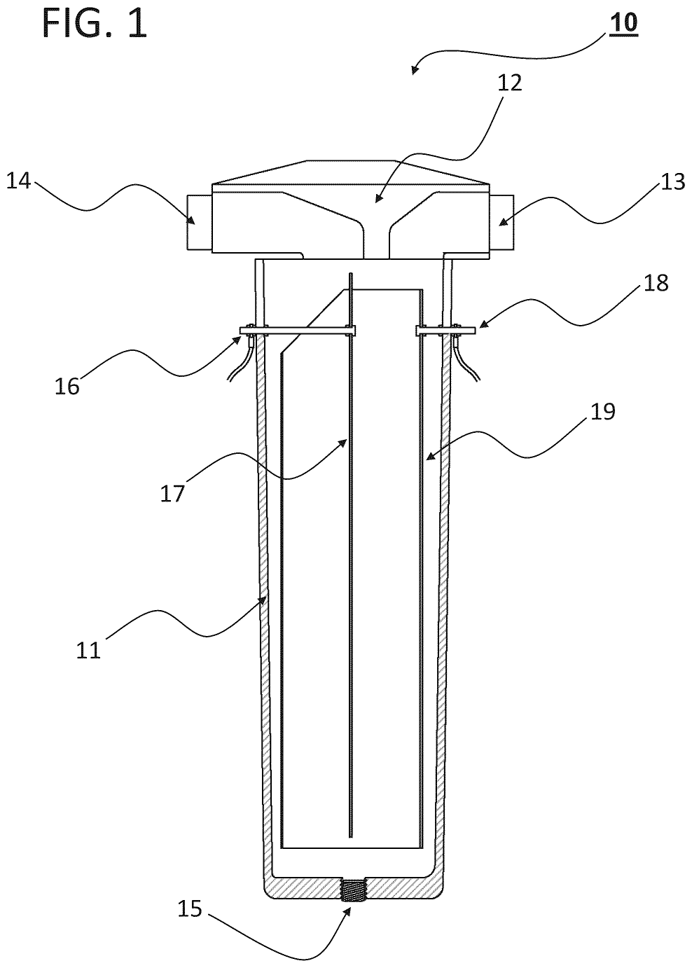

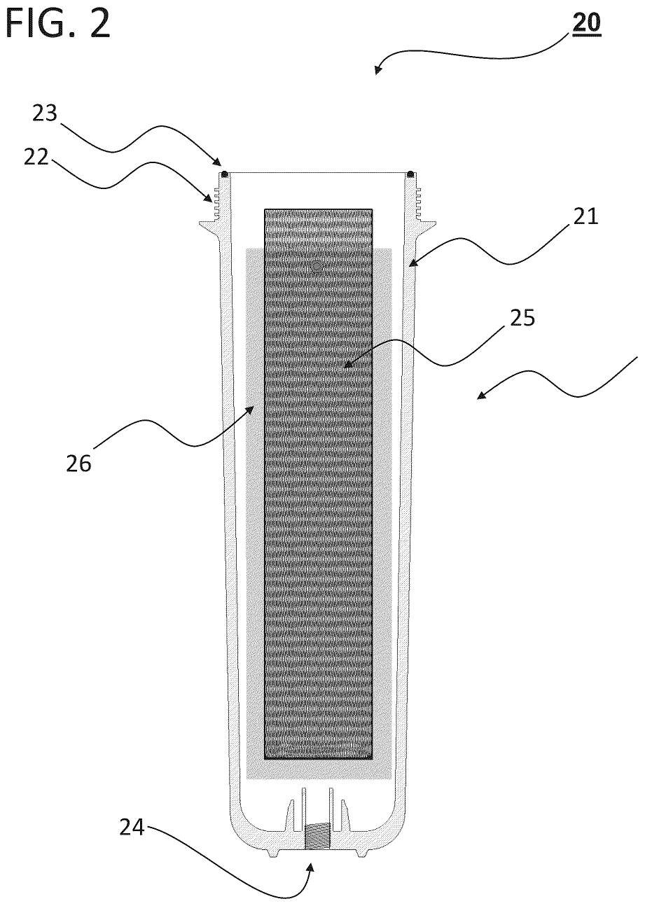

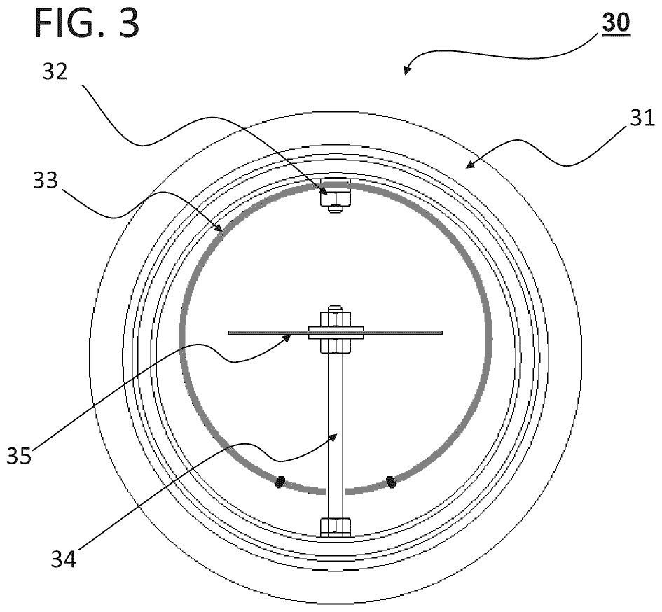

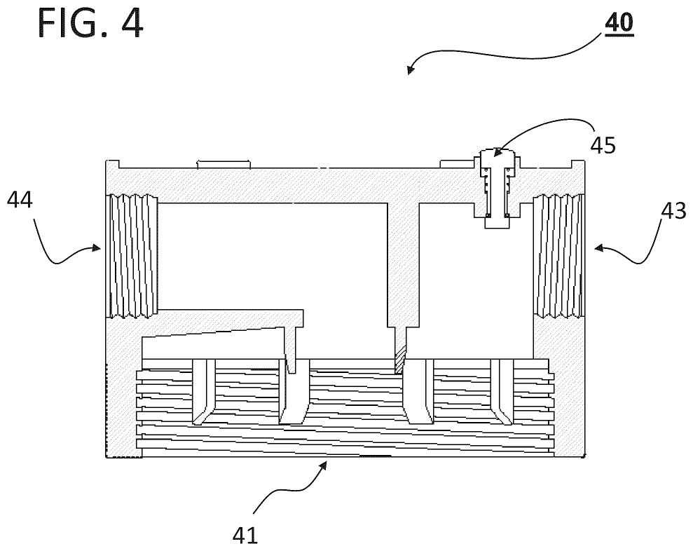

A device was built using a polymeric (e.g., plastic) casing (housing). In this non-limiting exemplary embodiment, presented in FIGS. 1-4, the device was configured to provide a desired flow rate is about 7 m³/h. At this flow rate, it is expected that within one hour of water softening, 56 grams of oxygen will be produced (7,000 liters×8 mg=56 grams), providing a flux of slightly less than one gram of oxygen per one minute of operation of the device at the upper oxygen saturation limit, considering that ambient air contains about 21% of oxygen.

The device dimension allow the use of a 400-800 cm² perforated plate or mesh type DSA. Considering the anode size, the cathode surface area should be at least 2-3X the size of the anode, and surround the anode so as to allow efficient mass transport in the system. Hence, the anode is placed in the center and along the longitudinal axis of a cylindrical cathode in a concentric manner, such that the cathode covers the whole geometric surface of the anode.

The device has been operated at the abovementioned flow rate while applying a constant current of 11 Amperes on 1,200×2 cm² of the cathode for both sides. At these operating setting and configuration, the amount of oxygen being produced at the anode in 1 hour tap water flow is about 105 grams (method of capacity calculations: 1 gram of a substance that accept/deliver 1 electron provides a capacity of 26.8 Ah). This amount of oxygen has been produced in a continuous mode of operation.

Assuming a maximal oxygen dissolution to be 1.22×10−3 mol dm−3 (based on the average published in the literature), which translates into 1.22 mol/m³, (39 g/m³) and assuming a volume of 7 m³ (7,000 liters) being treated and passing/flowing within an hour, the total theoretical dissolution of 1.22×7=8.54 moles of oxygen in this volume (7 m³), without any external pressure to be built, as 8.54 moles of oxygen gas (MW of 32 g/mol) translates into 273.3 grams of O² while 11 Amperes (A) passing for 1 hour translate into a capacity of 11 A·hour (Ah).

Taking into consideration that oxygen is being reduced by a 4 electrons reaction, one can calculate that the capacity needed for a reduction of 1 mole of oxygen (32 grams) is 3.35 Ah. Thus, in 1 hour operation at a current of 11 A, it is expected to produce 107.2 grams of O₂, providing a solubility of about 40% of the oxygen.

This amount of oxygen is less than the maximal theoretical value of the oxygen solubility (273.3 grams), and therefore no pressure is building up in the device working under the herein provided design and operating parameters of flow, potential and current.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

In the claims:

1. A water softening electrolyzer device, comprising:
an anode;
a cathode;
a casing that comprises a top lid having a water inlet and a water outlet;
said anode and said cathode are each held at a fixed position by an anchor wire-guide for eclectically contact and positioning inside said casing; and
said casing is having a backwash drainage at the bottom thereof,
wherein:
said casing is made of a polymeric material;
said anode having a cylindrical or flat shape and positioned substantially at the center and along a longitudinal axis of said casing;
said cathode is cylindrical and positioned along a longitudinal axis of said casing, essentially around said anode, such that said anode is at a concentric position with respect to said cathode; and
the active surface area of said cathode is at least twice the active surface area of said anode.

2. The device of claim 1, further comprising an electric power source configured to operate at:
a polarization potential that ranges from about −1.1 V to about −0.9 V against a saturated calomel electrode (SCE); and
a current density of less than about 10 mA/cm².

3. The device of claim 1, configured to electrochemically soften water at a flow rate of at least 3 m³/h while maintaining an internal pressure of less than 1.2 atm.

4. The device of claim 3, wherein said internal pressure is formed essentially from oxygen gas.

5. The device of claim 1, further comprising at least one of:
a water flow detector;
a water flow controller;
an electrical current controller;
a gas pressure detector; and
a head-space vent.

6. The device of claim 1, wherein said anode comprises a corrosion-resistant conductor core and an oxide coating.

7. The device of claim 6, wherein said resistant conductor core is a titanium plate.

8. The device of claim 6, wherein said oxide coating comprises a conductive catalyst selected from the group consisting of RuO₂, IrO₂, and PtO₂.

9. The device of claim 1, wherein said casing is having a cylindrical or truncated cone shape.

10. A process for softening tap water, comprising:
flowing the tap water through the device of claim 1 at a flow rate of at least 3 m³/h,
the process is characterized by developing an internal pressure of less than 1.2 atm.

11. The process of claim 10, effected while maintaining:
a polarization potential between said anode and said cathode at a range of about −1.1 V to about −0.9 V against a saturated calomel electrode (SCE); and
a current density of less than about 10 mA/cm².

12. The process of claim 11, characterized by electrochemically producing O₂ at a rate of at least 50 gram/h.
